(19) United States
(12) Patent Application Publication
(10) Pub. No.: US 2003/0033549 A1
(43) Pub. Date: Feb. 13, 2003

(54) Data storage device and data saving method thereof

(76) Inventor: Sheng-Yen Liu, Taipei (TW)

Correspondence Address: Raymond Sun, 12420 Woodhall Way, Tustin, CA, 92782, US

(21) Appl. No.: 09/927,828

(22) Filed: Aug. 10, 2001

(51) Int. Cl. G06F 13/00; G06F 1/26

(52) U.S. Cl. 713/300; 711/105; 711/111; 711/162

(57) ABSTRACT

A data storage device is applied to store digital medium data by using the DRAM to replace the flash memories for data storage. The data storage device comprises an interface converter used for transforming an interface of a flash memory into an interface of a dynamic random access memory. The interface converter is connected to a dynamic random access memory for storing the data stored in the data storage device. Further, the data storage device also comprises a battery capacity detector used to detect the capacity of a battery connected with the data storage device and deliver a signal representing the battery capacity into a controller. When the battery capacity detector detects the battery capacity reaching a pre-determined low electricity margin, the residual electricity is saved for the dynamic random access memory to operate the saving of the data and the high power-consuming components in the circuit are stopped.

### BACKGROUND OF THE INVENTION

1. Field of the Invention

The present invention is related to a data storage device and a data saving method thereof, and more particularly, to a data storage device for use in a digital sound player (MP3 player), a digital camera, a portable hard disk, and other devices for digital data storage.

2. Description of the Prior Art

For general data storage device, flash memories are widely used as the memory for data storage. For example, the memories used in data storage devices such as a digital sound player (MP3 player), a digital camera, a portable hard disk, and other devices are flash memories. Even though using a flash memory has the advantage of simultaneously saving the stored data when the power is turned off, it also suffers from a high fabrication cost due to the employment of a flash memory.

Therefore, the present invention provides a dynamic random access memory (DRAM) to replace the conventional flash memory so as to overcome the fore mentioned drawback. That is this invention could save the stored data when the power is turned off under using DRAM.

### SUMMARY OF THE INVENTION

It is the primary object of the present invention to provide a data storage device and a data saving method thereof to effectively reduce the fabrication cost.

It is another object of the present invention to provide a data storage device and a data saving method thereof that can be applicable to other non-flash memories and precisely detect the battery capacity.

It is another object of the present invention to provide a data storage device and a data saving method thereof that can be applicable to other non-flash memories and save the stored data to prevent the data from being lost when the power is turned off.

In order to achieve the foregoing objects, the present invention provides a data storage device comprising an interface converter used to transform an interface of a flash memory into an interface of a dynamic random access memory. The data storage device also comprises a dynamic random access memory connected to the interface converter for storing the data stored in the data storage device. Further, a battery capacity detector is comprised in the data storage device to detect the capacity of a battery connected to the data storage device and deliver a signal representing the battery capacity into a controller.

When the battery capacity detector detects the battery capacity reaching a pre-determined low electricity margin, the residual electricity is saved for the dynamic random access memory to operate the saving of the data and the high power-consuming components in the circuit are stopped.

It is preferable that the data storage device of the present invention further comprises a controller, connected to a display device, a player, and a transmission interface; the data storage device is used in a digital sound reproduction device.

It is preferable that the data storage device of the present invention further comprises a controller, connected to a charge coupled device (CCD) circuit, a display device, and a transmission interface; the data storage device is used in a digital camera for photographing.

It is preferable that the data storage device of the present invention further comprises a controller, connected to a hard disk peripheral circuit, a display device and a transmission interface; the data storage device is used in a portable hard disk.

It is preferable that the present invention provides a data saving method of the data storage device, comprising the steps of: precisely detecting the battery capacity of a battery connected to the data storage device; determining if the battery reaches a pre-determined low electricity margin; supplying the dynamic random access memory with the residual electricity so as to operate the saving of the data and stopping the other devices connected to the data storage device when the battery is detected reaching a pre-determined low electricity margin; and displaying that the battery is running out of electricity.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a circuit diagram in accordance with the first embodiment of the present invention;

FIG. 2 is a circuit diagram in accordance with the second embodiment of the present invention;

FIG. 3 is a circuit diagram in accordance with the third embodiment of the present invention; and

FIG. 4 is a flow chart showing a data saving method of the data storage device in accordance with the present invention.

### DETAILED DESCRIPTION OF THE INVENTION

The present invention provides a data storage device and a data saving method thereof for use in a digital sound player (MP3 player), a digital camera, a portable hard disk, and other devices for digital data storage. In the data storage device of the present invention, a dynamic random access memory (DRAM) is employed to replace the conventional flash memory so as to overcome the fore mentioned drawback, reduce the fabrication cost, and simply the circuit. However, when a dynamic random access memory (DRAM) is used, we must consider how to save the stored data by using the dynamic random access memory as a conventional flash memory when the battery capacity is detected reaching a pre-determined low electricity margin.

Therefore, the data storage device is used in combination with a precise battery capacity detecting method for precisely detecting if the battery reaches a pre-determined low electricity margin. When the battery is detected reaching a pre-determined low electricity margin, the residual electricity is saved for a dynamic random access memory to operate the saving of the data and the high power-consuming components in the circuit are stopped. However, in a normal case, the battery also supplies the dynamic random access memory to perform data storage.

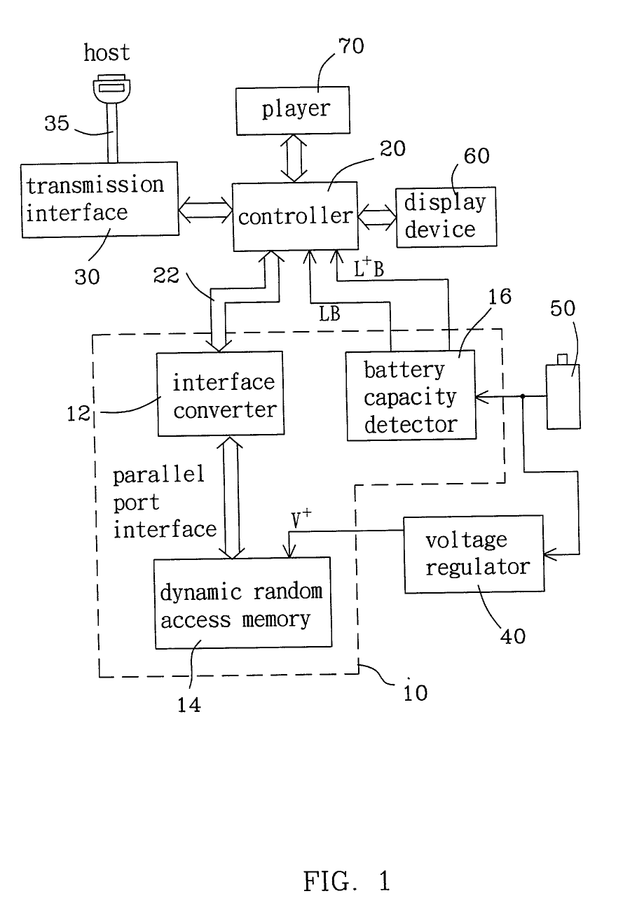

Please refer to FIG. 1, which is a circuit diagram in accordance with the first embodiment of the present invention, characterized in that the data storage device of the present invention is used in a digital sound player (e.g., MP3 player). The data storage device 10 of the present invention comprising an interface converter 12 used for transforming an interface of a flash memory into an interface of a dynamic random access memory (DRAM) type. The interface converter 12 is connected to a dynamic random access memory 14 for storing the data stored in the data storage is device 10. Wherein, a parallel port interface is used to connect the interface converter 12 and the dynamic random access memory 14. The data storage device 10 also includes a battery capacity detector 16 used to detect the capacity of a battery 50 which connected to the data storage device 10 and deliver a signal representing the battery capacity into a controller 20. When the battery capacity detector 16 detects the battery 50 reaching a pre-determined low electricity margin, the residual electricity is saved for the dynamic random access memory 14 to operate the saving of the data and the high power-consuming components in the circuit are stopped.

The battery capacity detector 16 as shown in FIG. 1 can comprise an integrator connected to a digital-analog converter (not shown in FIG. 1) so as to precisely calculate the residual electricity and decide if the other components should be turned off or not. Also, as shown in the figure, the data storage device 10 is further connected to a rechargeable battery 50 to provide sufficient electricity. Furthermore, the data storage device 10 is connected to a controller 20. The controller 20 serves as a controller of the digital sound player (e.g., MP3 player) and can be implemented by using a digital signal processor (DSP) or a microprocessor.

As shown in FIG. 1, the controller 20 and the interface converter 12 are connected via a connecting interface 22. Moreover, the controller 20 is further connected to a display device 60 that is used for displaying the battery capacity or the state of the digital sound player (MP3 player). In practical use, the display device 60 can be implemented by using a liquid crystal display (LCD), a thin film transistor liquid crystal display (TFT-LCD), or a light-emitting diode (LED) so that the battery capacity can be obtained. In addition, the controller 20 in FIG. 1 is further connected to a player 70 that is used for playing the stored digital sound data. Moreover, the controller 20 is connected to a transmission interface 30 through which the controller 20 is further connected to the host via a cable 35. In such a manner, the data storage device 10, the controller 20, the display device 60, the player 70 and the transmission interface 30 are combined to construct a digital sound player (e.g., MP3 player).

It is notable that, in FIG. 1, LB denotes a signal representing a low electricity margin; while LB⁺ denotes a signal representing a further detecting of the battery capacity so that the residual electricity is saved for the dynamic random access memory 14 to operate the saving of the data and the high power-consuming components in the circuit are stopped.

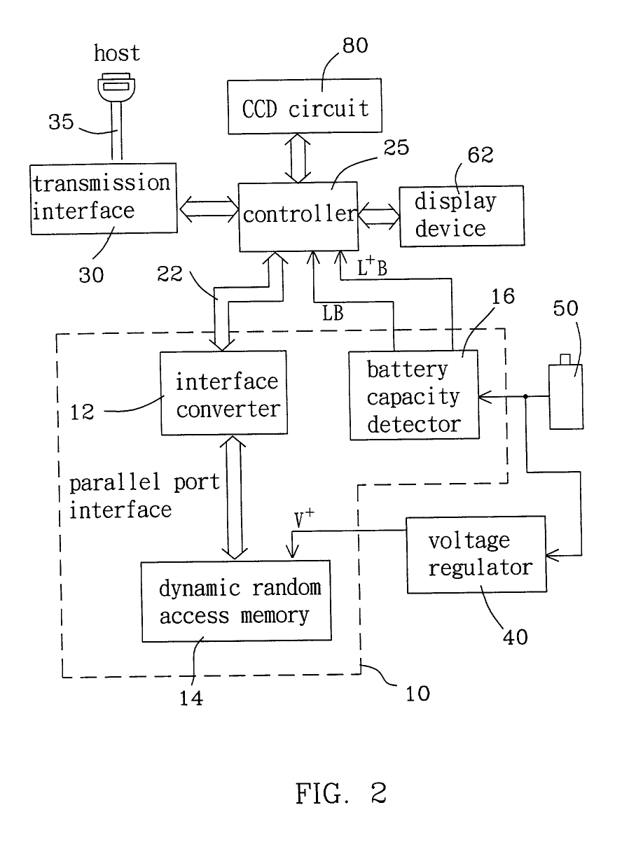

The data storage device 10 of the present invention is also used in a digital camera. Please refer to FIG. 2, which is a circuit diagram in accordance with the second embodiment of the present invention. The data storage device 10 of the second embodiment comprises an interface converter 12, a dynamic random access memory 14, and a battery capacity detector 16. The major difference between the first embodiment and the second embodiment is that the controller 25 serves as a controller of the digital camera and can be implemented by using a digital signal processor (DSP) or a microprocessor.

As shown in FIG. 2, the controller 25 and the interface converter 12 are connected via a connecting interface 22. Moreover, the controller 25 in FIG. 2 is further connected to a charge-coupled device (CCD) circuit 80 that is used for signal processing of the image. Moreover, the controller 25 is further connected to a display device 62 that is used for displaying the battery capacity or the state of the digital camera. In practical use, the display device 62 can be implemented by using a liquid crystal display (LCD), a thin film transistor liquid crystal display (TFT-LCD), or a light-emitting diode (LED) so that the battery capacity can be obtained. Furthermore, the controller 25 is connected to a transmission interface 30 through which the controller 25 is further connected to the host via a cable 35. In such a manner, the data storage device 10, the controller 25, the display device 62, the charge-coupled device (CCD) circuit 80 and the transmission interface 30 are combined to construct a digital camera.

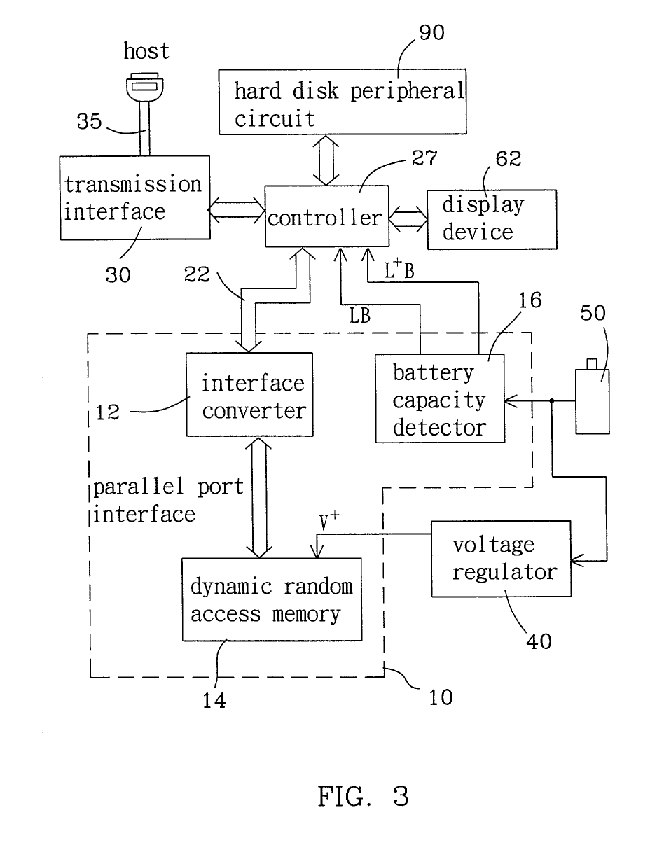

The data storage device 10 of the present invention is also used in a portable hard disk. Please refer to FIG. 3, which is a circuit diagram in accordance with the third embodiment of the present invention. The data storage device 10 of the third embodiment comprises an interface converter 12, a dynamic random access memory 14, and a battery capacity detector 16. The major difference between the first embodiment and the third embodiment is that the controller 27 serves as a controller of the portable hard disk and can be implemented by using a microprocessor.

As shown in FIG. 3, the controller 27 and the interface converter 12 are connected via a connecting interface 22. Moreover, the controller 27 in FIG. 3 is further connected to a hard disk peripheral circuit 90 that is used for accessing the data. Moreover, the controller 27 is further connected to a display device 62 that is used for displaying the battery capacity. In practical use, the display device 62 can be implemented by using a liquid crystal display (LCD), a thin film transistor liquid crystal display (TFT-LCD), or a light-emitting diode (LED) so that the battery capacity can be obtained. Furthermore, the controller 27 is connected to a transmission interface 30 through which the controller 27 is further connected to the host via a cable 35. In such a manner, the data storage device 10, the controller 27, the display device 62, the hard disk peripheral circuit 90 and the transmission interface 30 are combined to construct a portable hard disk.

On the other hand, the data storage device 10 of the present invention is further used in a mobile phone so as to reduce the fabrication cost of the mobile phone.

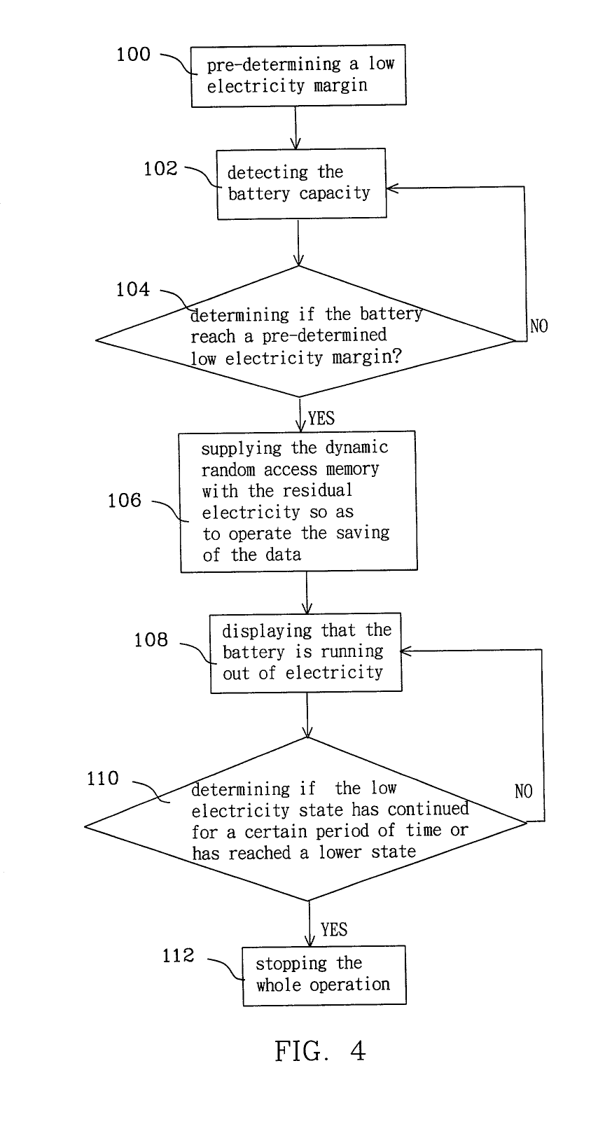

The present invention further provides a data saving method of the data storage device 10. Please refer to FIG. 4, which is a flow chart showing a data saving method of the data storage device 10 in accordance with the present invention. The data saving method comprises the steps of: pre-determining a low electricity margin 100; precisely detecting the battery capacity of a battery connected to the data storage device 102; determining if the battery reaches the pre-determined low electricity margin 104; if not, returning to step 102, while if yes, supplying the dynamic random access memory with the residual electricity so as to operate the saving of the data and stopping the other devices connected to said data storage device 106; and displaying that the battery is running out of electricity 108.

The method as shown in FIG. 4 further comprises the steps of: determining if the low electricity state has continued for a certain period of time or has reached a lower state 110; and if yes, stopping the whole operation 112. In such a manner, the data saving method can be completed. On the other hand, the step of precisely detecting the battery capacity comprises detecting the battery current and performing integration so as to obtain the ampere-hour capacity of the battery; and converting the ampere-hour of the battery into a desired signal by using a digital-analog converter.

It is preferable that the data saving method of the data storage device according to the present invention further comprises a step of starting a stand-by power supply so as to prevent the data from being lost due to the lack of electricity. The step of starting a stand-by power supply further comprises the steps of: detecting the electricity state of a main battery in the data storage device of the present invention; determining if the main battery reaches a pre-determined low electricity margin; starting a stand-by power supply when the battery reaches the pre-determined low electricity margin; supplying the memory of the data storage device with the stand-by power so as to operate the saving of the data; and displaying that the main battery needs to be replaced or recharged. Particularly, the stand-by power supply can be implemented by using a battery for supplying the memory in addition to the main battery.

As mention above, by replacing the conventional flash memory with a dynamic random access memory (DRAM), the data storage device as well as the data saving method thereof can effectively reduce the fabrication cost. More particularly, in order to prevent the data from being lost when the power is unexpectedly turned off, the present invention further provides a method for precisely detecting the battery capacity, in which the other components in the circuits are stopped when the battery reaches a pre-determined low electricity margin and the residual electricity is saved for the dynamic random access memory to operating the saving of the data. In this manner, using the dynamic random access memory as a conventional flash memory saves the stored data.

Therefore, the present invention has been examined to be progressive and has great potential in commercial applications.

Although this invention has been disclosed and illustrated with reference to particular embodiments, the principles involved are susceptible for use in numerous other embodiments that will be apparent to persons skilled in the art. This invention is, thereof, to be limited only as indicated by the scope of the appended claims.

What is claimed is:

1. A data storage device, comprising:
an interface converter, for transforming an interface of a flash memory into an interface of a dynamic random access memory;
a dynamic random access memory, connected to said interface converter for storing the data stored in said data storage device; and
a battery capacity detector, for detecting the capacity of a battery connected with said data storage device and deliver a signal representing the battery capacity into a controller; and
wherein, when said battery capacity detector detects said battery reaching a pre-determined low electricity margin, the residual electricity is saved for said dynamic random access memory to operate the saving of the data and the high power-consuming components in the circuit are stopped.

2. The data storage device as recited in claim 1, wherein said battery capacity detector comprises an integrator connected to a digital-analog converter so as to precisely calculate the residual electricity.

3. The data storage device as recited in claim 1, is further connected to a rechargeable battery to provide sufficient electricity.

4. The data storage device as recited in claim 1, is further connected to a controller that connected to a display device, a player, and a transmission interface, wherein said data storage device is used in a digital sound player.

5. The data storage device as recited in claim 4, wherein said transmission interface is connected to the host via a cable.

6. The data storage device as recited in claim 4, wherein said display device is implemented by using a liquid crystal display (LCD), a thin film transistor liquid crystal display (TFT-LCD), or a light-emitting diode (LED).

7. The data storage device as recited in claim 1, is further connected to a controller that connected to a charge coupled device (CCD) circuit, a display device, and a transmission interface, wherein said data storage device is used in a digital camera for photographing.

8. The data storage device as recited in claim 7, wherein said transmission interface is connected to the host via a cable.

9. The data storage device as recited in claim 7, wherein said display device is implemented by using a liquid crystal display (LCD), a thin film transistor liquid crystal display (TFT-LCD), or a light-emitting diode (LED).

10. The data storage device as recited in claim 1, is further connected to a controller that connected to a hard disk peripheral circuit, a display device and a transmission interface, wherein said data storage device is used in a portable hard disk.

11. The data storage device as recited in claim 10, wherein said transmission interface is connected to the host via a cable.

12. The data storage device as recited in claim 10, wherein said display device is implemented by using a liquid crystal display (LCD), a thin film transistor liquid crystal display (TFT-LCD), or a light-emitting diode (LED).

13. A data saving method of said data storage device, comprising the steps of:
precisely detecting the battery capacity of a battery connected to said data storage device;
determining if said battery reaches a pre-determined low electricity margin;
supplying said dynamic random access memory with the residual electricity so as to operate the saving of the data and stopping the other devices connected to said data storage device when said battery is detected reaching a pre-determined low electricity margin; and
displaying that said battery is running out of electricity.

14. The data saving method as recited in claim 13, further comprising a step after said step of displaying that said battery is running out of electricity:
determining if the low electricity state has continued for a certain period of time or has reached a lower state; and if yes, stopping the whole operation.

15. The data saving method as recited in claim 13, wherein said step of precisely detecting the battery capacity comprises a step of detecting the battery current and performing integration so as to obtain the ampere-hour capacity of said battery.

16. The data saving method as recited in claim 13, further comprising a step of converting the ampere-hour capacity of said battery into a desired signal by using a digital-analog converter.

17. The data saving method as recited in claim 13, wherein said step of determining if said battery reaches a pre-determined low electricity margin further comprises a step of starting a stand-by power supply so as to prevent the data from being lost due to the lack of electricity.

18. A data saving method of said data storage device, comprising the steps of:
detecting the electricity state of a main battery in said data storage device;
determining if said main battery reaches a pre-determined low electricity margin;
starting a stand-by power supply when said battery reaches the pre-determined low electricity margin;
supplying said memory of said data storage device with said stand-by power so as to operate the saving of the data; and
displaying that said main battery needs to be replaced or recharged.

19. The data saving method as recited in claim 18, wherein said stand-by power supply is implemented by using a battery for supplying said memory in addition to said main battery.
